(19) United States
(12) Patent Application Publication
(10) Pub. No.: US 2025/0278785 A1
(43) Pub. Date: Sep. 4, 2025

(54) PRESCRIPTION EXCHANGE PLATFORMS, METHODS, AND SYSTEMS

(71) Applicant: Stratis Group, LLC, Palm Beach Gardens, FL (US)

(72) Inventors: Acacia Cormier, Marshfield, MA (US); Joseph Musumeci, Palm Beach Gardens, FL (US)

(21) Appl. No.: 19/064,189

(22) Filed: Feb. 26, 2025

Related U.S. Application Data
(60) Provisional application No. 63/559,484, filed on Feb. 29, 2024.

(51) Int. Cl. G06Q 40/04; G06Q 30/0226; G06Q 30/06

(52) U.S. Cl. CPC G06Q 40/04; G06Q 30/0226; G06Q 30/06

(57) ABSTRACT

A computer-based method coordinates a purchase, such as the purchase of prescription medication. An exchange platform receives an indication that a buyer wishes to purchase a prescription-based product from a primary seller. The method then evaluates a hypothetical sale of the prescription-based product from the primary seller to determine whether such a sale would be profitable. Upon determining that the hypothetical sale of the prescription-based product from the primary seller would not be profitable, the method evaluates an equivalent hypothetical sale from at least one secondary seller, such as a third party pharmacy. Upon determining that the equivalent hypothetical sale from a selected seller of the at least one secondary seller would be profitable, the method initiates a transfer of the indication from the primary seller to the selected seller.

### CROSS-REFERENCE TO RELATED APPLICATIONS

This application claims the benefit of U.S. Provisional Application No. 63/559,484, filed Feb. 29, 2024, the entire contents of which are incorporated by reference herein.

### FIELD OF THE INVENTION

The invention relates to improving patient access to prescription-based products, such as medications, by providing methods, systems, and platforms by which pharmacies can transfer non-profitable prescriptions to alternative pharmacies.

### BACKGROUND

Traditionally, prescription-based products, such as medications, flow from manufacturers to buyers, typically patients, by way of pharmacies. The pharmacy is typically immediately upstream of the patient and is tasked with dispensing the medications to the patients.

Improving patient access to medications is a longstanding challenge, and pharmacies create a bottleneck in distribution. Traditional programs for improving access approach the issue from the manufacturing side by, e.g., providing discounts or rebates to patients who qualify. Other participants in such a transaction may attempt to provide assistance as well. Accordingly, prescribers, such as medical providers, and payors, such as insurance companies and government programs, may provide subsidies, rebates, or reimbursements.

However, from the perspective of a patient, all of these attempts to improve access are provided from the manufacturer side of the transaction, and as such, the pharmacy itself remains a bottleneck.

With this in mind, there are various reasons that pharmacies may function as a bottleneck in the medication distribution process. Typically, upwards of 30% of prescriptions filled at pharmacies are underwater, in that they lose money for the pharmacy. When a pharmacy grosses $10 on a set of transactions, but loses $3, the current approach is to find ways for the pharmacy to earn more money to cover the loss. Increasing sales and reducing costs exacerbates the situation that creates the bottleneck in the first place.

A more efficient approach may be to avoid the loss in the first place. However, having the pharmacy refuse transactions that generate losses would further harm patient access to medications. Further, pharmacies want to be one-stop shops for all prescription-based products and may be hesitant to turn away business on specific medications even if they are then forced to view those medications as loss leaders.

Because different pharmacies may have different relationships with different drug manufacturers and insurers, there may be scenarios where a medication that is not profitable for a first pharmacy to sell may be profitable for a second pharmacy to sell. However, the first pharmacy may not want to direct a customer to purchase from their competitor instead of themselves.

There is therefore a need for methods, systems, and platforms that can allow pharmacies to transfer prescriptions determined not to be profitable to alternative pharmacies without damaging their relationship with their customers. There is a further need for a system and platform that can maintain incentives for pharmacies to provide strong service while improving cost efficiencies.

### SUMMARY

As discussed above, traditionally, prescription-based products, such as medications, flow from manufacturers to buyers, typically patients, by way of pharmacies. The pharmacy is typically immediately upstream of the patient and is tasked with dispensing the medications to the patients.

The pharmacy then functions as a bottleneck, particularly if they fill many subscriptions that they ultimately lose money on. The upstream impact of increasing profitability by reducing losses at pharmacies would then flow back up through the supply chain.

If losses on individual sales at pharmacies can be reduced or eliminated, more prescriptions can flow to patients with the same efforts from all parties upstream.

Pharmacies would be able to support more resourcing at the point of sale, which would in turn improve customer service, increase available bandwidth at the pharmacy, and provide an increased ability to execute on opportunities for additional supplemental dollars from pharmaceutical sales which could yield additional profit.

This would further enhance incentives for pharmacies to improve customer service, since additional sales would consistently yield additional profit. More patients would then be treated, which over time may be expected to reduce the cost of healthcare to payers, despite the potential nominal increase in payer spend in the shorter term arising from more successfully filled prescriptions.

Manufacturers might then see more volume shifted to higher-cost distribution paths, but would have better outcomes on tactical investments, and could therefore spend less on pull through, resulting in more cash on hand for spending on R&D among other potential investments.

An efficient allocation of prescriptions could then improve outcomes for various parties with minimal impact on workflow for individual pharmacies.

In order to effectively mitigate losses at pharmacies, the reimbursement of a prescription medication should be understood on a granular level. Such a reimbursement typically has several components, including:
The cost for a pharmacy to purchase the medication from a distributor;
The cost of labor to navigate payor criteria (e.g., steps and PAs), patient out of pocket costs (including copay programs), and physical dispensing logistics (including product movement, shipping for mail orders, etc.);
Reimbursements from the payer, the manufacturer, or any special programs available in a specific scenario (e.g., copay cards and vouchers); and
Fees from manufacturers to execute special programs and data.

Because of the large number of components, it is very difficult for a pharmacy to combine these metrics on a per-script level and assess profitability—particularly if they attempt to evaluate the metrics preemptively.

Further, factors of these calculations, such as reimbursements from payers, may vary from pharmacy to pharmacy based on individual contracts. Accordingly, some pharmacies will lose money on the same prescriptions that other pharmacies may net a profit on.

Methods, systems, and platforms are therefore described herein by which an exchange platform can evaluate any hypothetical sale described by a particular prescription and evaluate net profit for the particular sale of a prescription-based product.

A pharmacy may then set a net profit target for any single prescription-based sale, and when a prescription falls under the net profit target, the exchange platform can match up the drug and dosage with a pharmacy where it does hit a corresponding target profit. This determination may include, e.g., shipping to the patient if out of local pickup range, as well as any fees or transaction costs associated with transferring the prescription. The exchange would then support a pharmacy-to-pharmacy transfer for the prescription, engaging the patient at the point of sale of the transferring pharmacy (if the patient is there in person).

In a typical implementation, the transferring pharmacy may then receive a transfer fee, such as a percentage of the net profit of the receiving pharmacy. The transferring pharmacy may get further fees or reimbursements if they managed the patients copay, enrolled the patient in hubs, or supported a PA involved in the case.

The transferring pharmacy may also receive scores in the context of the exchange platform in order to incentivize the use of the exchange platform to push out unprofitable prescriptions. For example, the transferring pharmacy may receive points associated with the exchange platform based on a number of prescriptions they have pushed to the exchange. Additionally, or alternatively, the transferring pharmacy may receive “miles” for every dollar of net profitability they have pushed onto the platform.

In a typical implementation, a receiving pharmacy will then receive all information necessary to dispense the subject of the prescription with known profitability. Points associated with a transfer may be symmetric, such that as the transferring pharmacy gains a “point” for pushing a medication to the platform, the receiving pharmacy may lose a point. In some embodiments, they also “use” their miles based on net profitability.

In some embodiments, pushing a prescription to the platform may inherently give a pharmacy more miles than the cost of dispensing, since miles calculated for a transferring pharmacy may be based on an initial calculation of net profitability for a prescription. A transfer fee, along with any other fees, may then be subtracted from that net profitability, resulting in a reduced profitability.

In some embodiments, the platform itself may be funded by a percentage of each transaction. In such a “rake” may be subtracted from the net profitability of individual transactions as well.

The methods and systems described herein, such as the exchange platform described herein can provide various advantages. The platform may encourage otherwise unprofitable prescriptions to be pushed to a pharmacy where they are profitable. This may also increase bandwidth and open pharmacies up to receiving and dispensing prescriptions that are profitable to them.

The methods and systems described herein may further encourage pharmacies to work all prescriptions, even if unprofitable, since they earn something for those prescriptions if pushed to the exchange platform. The methods and systems also provide a mechanism to calculate and set thresholds that include resourcing, allowing pharmacies to mitigate dispensing prescriptions that would ultimately cost them money. These criteria may be based on straight reimbursement, or they may factor in payer criteria and/or time spent helping the customer/patient navigate the affordability options.

The methods and systems may operate by flagging prescriptions at the point of sale and offering an option for a tech or pharmacist to shop the prescription to the exchange for the patient, which could potentially generate a win-win scenario. This approach may use only the drug and dosage to bump up against a live database of local and national pharmacies that can dispense the medication profitably for the patient. The patient out of pocket component may be evaluated for all pharmacies in the back end and applied to net profitability.

This approach may simply return a “shopped” response in near real time, such that if the tech or pharmacist has the patient in front of them, or on the phone, they can provide an immediate solution presented to the patient.

In some embodiments a computer-based method is provided for coordinating a purchase, such as the purchase of prescription medication discussed above. Such a method includes receiving, at an exchange platform, an indication that a buyer wishes to purchase a prescription-based product from a primary seller. The primary seller would typically be the buyer's primary pharmacy. The method then evaluates a hypothetical sale of the prescription-based product from the primary seller to determine whether such a sale would be profitable. Upon determining that the hypothetical sale of the prescription-based product from the primary seller would not be profitable, the method evaluates an equivalent hypothetical sale from at least one secondary seller, such as a third party pharmacy. Upon determining that the equivalent hypothetical sale from a selected seller of the at least one secondary seller would be profitable, the method initiates a transfer of the indication from the primary seller to the selected seller.

In some embodiments, the indication that a buyer wishes to purchase the prescription-based product is a prescription from a health care provider indicating a patient as the buyer. In some such embodiments, the prescription is initially received at the exchange platform from the primary seller, and the initiation of the transfer of the indication is a transfer of the prescription from the primary seller to the selected seller.

In some embodiments where the indication is a prescription, the prescription is initially received from the health care provider and indicates the primary seller as a preferred pharmacy.

In some embodiments, the evaluation of the hypothetical sale from the primary seller is based at least partially on data retrieved from or associated with the primary seller following the receipt of the indication at the exchange platform. The evaluation of the equivalent hypothetical sale from the selected seller is then based on data retrieved from or associated with the selected seller following the determination that the hypothetical sale from the primary seller would not be profitable.

In some such embodiments, the data retrieved from or associated with the primary seller is not accessible by the selected seller and the data retrieved from or associated with the selected seller is not accessible by the primary seller.

In some embodiments utilizing such data, the method includes maintaining communication pathways with each of the primary seller and the selected seller such that the retrieval of data occurs in real time.

In some embodiments utilizing such data, the data retrieved from the primary seller indicates product purchase data and payer reimbursement data unique to the primary seller and wherein the data retrieved from the selected seller indicates product purchase data and payer reimbursement data unique to the selected seller and different than that of the first seller. In some such embodiments, the evaluation of the hypothetical sale from the primary seller and the evaluation of the equivalent hypothetical sale from the at least one secondary seller are each further based on available reimbursements from a manufacturer or payer applicable to either hypothetical sale.

In some embodiments, the method includes transmitting a notice to the buyer or to the primary seller that the indication is being processed by the selected seller.

In some embodiments, the method includes maintaining an account for each of the primary seller and the at least one secondary seller, where the method is performed repeatedly, and where the method includes tracking a plurality of transfers of indications from the primary seller to a plurality of sellers of the at least one secondary seller including the selected seller over time.

In some such embodiments, upon confirming a transfer of the indication from the primary seller to the selected seller, the method applies a transfer fee to the account of the primary seller and charges the transfer fee to the account of the selected seller.

In some embodiments utilizing accounts, the method further includes, upon receiving confirmation that the buyer has made a partial payment to the primary seller, transmitting an indication to the selected seller that partial payment has been received, and applying a credit to the account of the selected seller in accordance with the partial payment.

In some embodiments utilizing accounts, the method further includes assigning loyalty points associated with the primary seller to the buyer upon the buyer purchasing the prescription-based product from the selected seller.

In some embodiments, upon determining that the equivalent hypothetical sale from the selected seller would not be profitable, the method may further include initiating a transfer of the indication from the primary seller to a backup pharmacy, where the backup pharmacy commits preemptively to fulfilling orders for eligible prescription-based products.

In some embodiments, the selected seller is a mail order pharmacy, such that upon confirming a transfer of the indication from the primary seller to the selected seller, the method further includes initiating an order corresponding to the indication.

In some embodiments, the determination that the sale of the prescription-based product from the primary seller would not be profitable is based on net profit compared to a minimal threshold profit.

Also provided is a system for coordinating a purchase, the system including a server, a primary seller interface device, and a secondary seller interface device. The primary seller interface device receives an indication that a buyer wishes to purchase a prescription-based product from the primary seller, the primary seller interface device then transmits an indication to the server that the buyer wishes to purchase the prescription-based product from the primary seller. The server then retrieves primary seller confidential data associated with the primary seller interface device and evaluates a hypothetical sale of the prescription-based product from the primary seller based at least partially on the primary seller confidential data. Upon determining that the hypothetical sale of the prescription-based product from the primary seller would not be profitable, the server further retrieves secondary seller confidential data associated with the secondary seller interface device and evaluates an equivalent hypothetical sale of the prescription-based product from the secondary seller based at least partially on the secondary seller confidential data.

Upon determining that the equivalent hypothetical sale from the secondary seller would be profitable, the server initiates a transfer of the indication from the primary seller interface device to the secondary seller interface device.

In some embodiments, the system further includes a database external to the server, the primary seller interface device and the secondary seller interface device, where the database contains primary seller confidential data or secondary seller confidential data. The server retrieves confidential data from the database upon authorization of such retrieval by the corresponding primary seller interface device or secondary seller interface device.

In some embodiments, the primary seller interface device is a computer system associated with a primary pharmacy, and the secondary seller interface device is a computer system associated with a secondary pharmacy, and the indication is a prescription issued by a healthcare provider.

### BRIEF DESCRIPTION OF THE DRAWINGS

FIG. 1 illustrates a system in accordance with this disclosure, as well as data flow within potential embodiments of the system.

FIG. 2 is a method for facilitating prescription exchanges in accordance with this disclosure.

FIG. 3 is a swim lane diagram illustrating interactions between parties within the system of FIG. 1.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

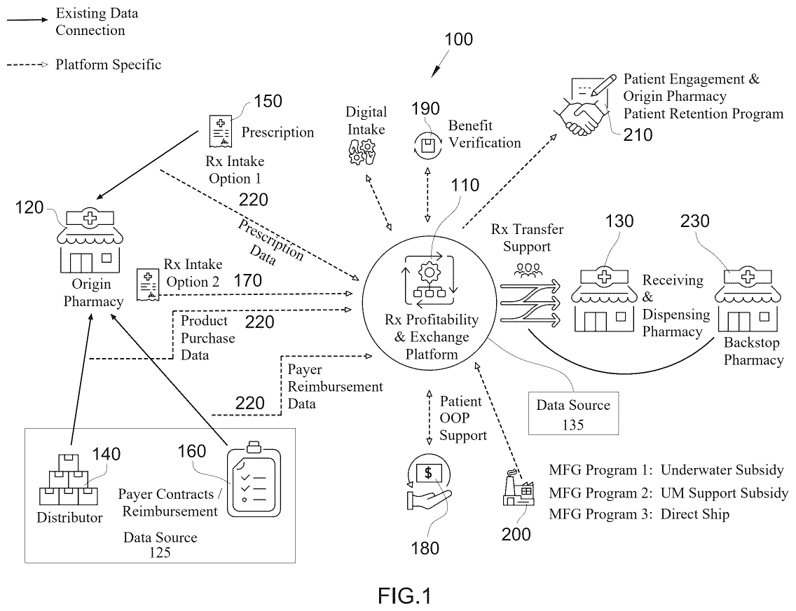

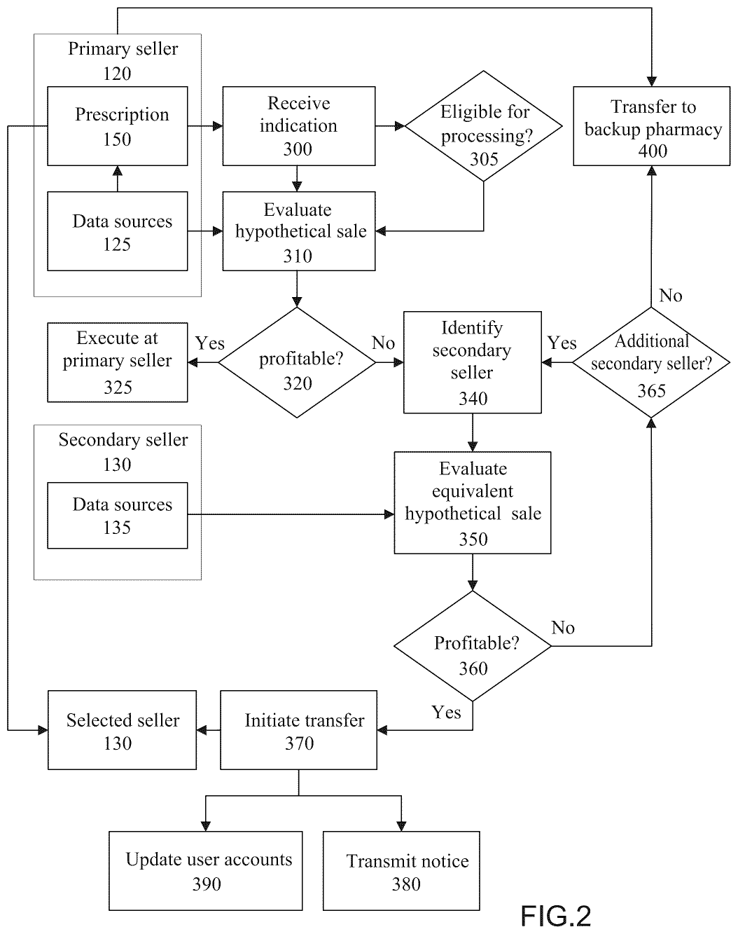

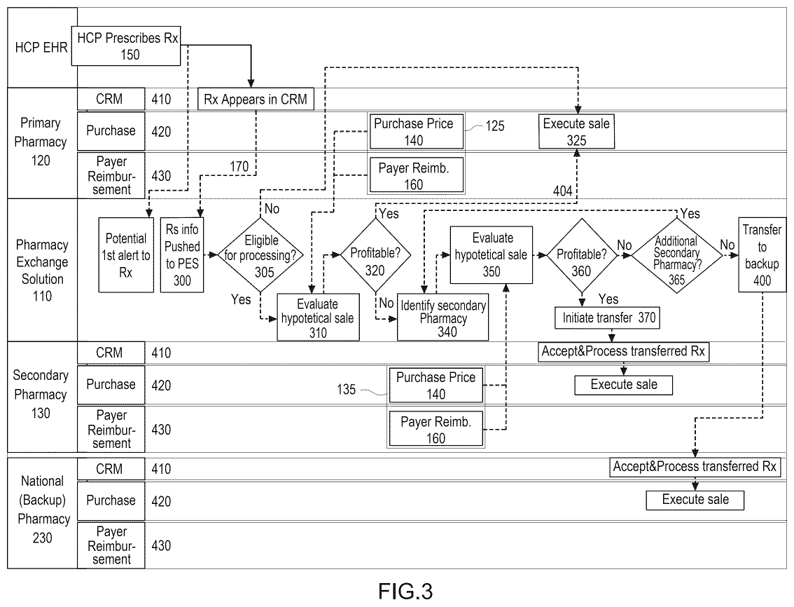

FIG. 1 illustrates a system in accordance with this disclosure, as well as data flow within potential embodiments of the system. FIG. 2 is a method for facilitating prescription exchanges in accordance with this disclosure. FIG. 3 is a swim lane diagram illustrating interactions between parties within the system of FIG. 1.

As shown in FIG. 1, a system 100 implementing the methods and platform described herein may include a central server 110, a primary seller interface device 120, and a secondary seller interface device 130. In FIG. 1, it is noted that the pharmacies themselves are shown, and typically maintain the corresponding interface devices 120, 130. Similarly, the central server 110 typically operates the prescription profitability and exchange platform described herein. For the purposes of this disclosure, the pharmacies, or potential sellers, may be referred to with the same reference numeral as their respective interface devices 120, 130. Accordingly, the primary pharmacy or the primary seller 120 and the secondary pharmacy or seller 130 may be referenced interchangeably with the corresponding interface devices. Similarly, the server and platform may be referred to as 110 interchangeably.

In some embodiments, a selected seller may be selected from a plurality of secondary sellers 130, and in such cases, the selected seller corresponds to the secondary seller that functions as the receiving and dispensing pharmacy 130 in FIG. 1. However, the selected seller 130 may ultimately be only one of many potential secondary sellers.

Various data connections are utilized by the platform with existing data connections shown in FIG. 1 in solid lines and platform specific data connections shown in dashed lines. Some such connections are bi-directional, while others, such as data feeds, may be read-only access to existing data sources already connected to the pharmacies 120, 130.

Various data sources 125, 135 provide information to one or more of the central server 110 and the seller interface devices 120, 130. Accordingly, the pharmacies 120, 130 may directly receive information from their distributors 140, and prescriptions 150 may be provided either by patients, or buyers, themselves (i.e., as hard copies) or directly from health care providers. Similarly, the patients themselves may direct their healthcare provider to direct their prescription 150 to a specific primary seller 120.

The primary pharmacy 120 may further receive data related to payer contracts and reimbursements 160. Each of these components of data may be received at the corresponding seller interface device 120 from corresponding data sources, which may be discrete data sources, or may be a single source of data 125. Further, such data sources 125 may be direct feeds provided to the pharmacy at the corresponding seller interface device 120, or the data sources may be available on the internet, such that each data component is retrievable from a depository of data.

While specific data sources 125 associated with the primary seller interface device 120 are shown as distributor 140 and payer contracts and reimbursements 160, it is noted that equivalent data sources 135 may be made available to the secondary seller interface device 130 supporting a secondary pharmacy. In the context of the methods described, the secondary pharmacy and related interface device 130 represent a receiving and dispensing pharmacy. However, additional pharmacies may participate in the platforms described herein and may be similarly provided with data sources.

The contents of the data sources 125, 135 may be unique to the particular pharmacy 120, 130 with which it is associated. Accordingly, because the primary pharmacy and corresponding interface device 120 may have a relationship with a payer, the payer contracts and reimbursement data 160 may not be fungible, and a corresponding data source 135 for the secondary seller interface device 130 may provide different data.

The primary seller interface device 120 and the secondary seller interface device 130 may then be provided with a communication pathway 170 with the central server 110. In some embodiments, secondary communication pathways 220 may be provided linking at least one of the secondary data sources 140, 150, 160 to the central server 110, such that the central server can be provided with direct access to such data. This direct access may be full access or it may be read-only access. Alternatively, all such data may be packaged with the prescription 150 and transmitted to the central server 110 by way of the communication pathway 170 from the primary seller interface device 120.

Additional data sources may be available directly to the central server 110, such that the server can evaluate patient out of pocket support programs 180 and verify access to benefits 190. The central server 110 may also be provided with access to data from manufacturers related to subsidies and promotional programs 200 as well as data related to patient engagement programs 210 associated with various pharmacies participating in the method, so as to allow the pharmacies 120, 130 to implement those programs in the event of prescription transfers.

Finally, in some embodiments, in addition to the primary pharmacy 120 and the plurality of secondary pharmacies (including the selected seller 130), the system 100 may include a backstop pharmacy 230. Such a pharmacy 230 may agree preemptively to accept and process prescriptions that cannot be profitably filled by the primary or secondary pharmacies 120, 130.

As shown in FIG. 3, each pharmacy 120, 130, 230 typically has their own point of sale (POS) system, which would include a customer relationship management (CRM) platform 410 used for managing incoming prescriptions, a purchasing platform 420 for managing pharmacy purchases and sales, and a payer reimbursement platform 430 for coordinating reimbursements from, e.g., insurance companies.

Additional components of the system 100 will become apparent in describing the methods performed thereby. The system 100 described may then be used to implement a computer-based method for coordinating a purchase. The purchase discussed is typically the purchase by a customer, or a patient, of a prescription-based product, such as a medication.

Initially, the exchange platform may receive (300), at the server 110, an indication that a buyer wishes to purchase a prescription-based product from a primary seller 120. The primary seller is typically the primary pharmacy 120 noted above, and the indication is typically a prescription 150 received from the primary seller interface device 120 or directly from a health care provider. This may be received by way of the communication pathway 170 between the server 110 and the primary seller interface device 120.

The method may initially evaluate (305) whether the proposed sale is eligible for processing on the platform. If the method determines that the proposed sale is eligible (at 305), the method proceeds with an evaluation (310) of a corresponding hypothetical sale.

In some embodiments, the evaluation of eligibility (at 305) may comprise a series of checks including checking whether the prescription information is incomplete and checking whether a prescription has been marked as ineligible, in which case the prescription will be removed from the system 110 and returned to the primary pharmacy 120. Similarly, certain drugs may be included on a list that excludes them from processing on the exchange platform 110, such as when the primary pharmacy 120 has excluded the drug by contract or when the medication is for acute treatment that should not be delayed. In these cases, the prescription 150 would typically be returned to the primary pharmacy 120 for immediate handling.

Accordingly, the method then proceeds to evaluate (310) a hypothetical sale of the prescription-based product from the primary seller. If the method determines (at 320) that the hypothetical sale would be profitable if executed by the primary seller 120, the method may indicate the same to the primary seller and take no further action. The primary seller 120, typically the origin pharmacy, can then execute (325) on their prescription the way they normally would.

While this determination is described as being performed at the server 110 by the exchange platform, it is noted that in some embodiments, this initial determination may be made directly by the pharmacy using their own criteria at their own interface devices 120. Accordingly, in some embodiments, the prescription or other indication may be transmitted (at 300) to the server 110 only if the primary seller 120 believes they cannot fulfill the request cost effectively.

In any event, following the evaluation (at 310) of a hypothetical sale by the primary seller 120, the method may proceed to determine (at 320) that the hypothetical sale of the prescription-based product from the primary seller 120 would not be profitable. Upon reaching such a determination (at 320), the method may then proceed to identify at least one secondary seller 130 (at 340) that could fulfill the order instead of the primary seller. The method then proceeds to evaluate (350) an equivalent hypothetical sale from the at least one secondary seller 130 to the buyer. Such an equivalent hypothetical sale may involve processing an equivalent prescription by the secondary seller 130.

In many cases, the at least one secondary seller may include a plurality of available secondary sellers that may be available to fulfill orders. The server 110 may maintain or have access to a database of pharmacies participating in the exchange program described herein. Accordingly, the method may initially select a seller 130 of the plurality of secondary sellers to evaluate (at 350) using the equivalent hypothetical sale.

In the context of the method described herein, many of the steps are described as associated with the selected seller. It is understood that the method may be performed iteratively. Accordingly, the method may iteratively evaluate (at 350) several potential sellers of the plurality of available secondary sellers. For any such seller, if the method determines (355) that the equivalent hypothetical sale would not be profitable, the method may then select a further potential seller for evaluation (at 350) and proceed until an appropriate secondary seller is identified (at 340) for selection. It is noted that in the discussion that follows, any step performed with respect to the “selected seller,” such as acquisition of data from data sources, may have been similarly performed with respect to other potential sellers as part of the evaluation process (at 350) prior to settling on the selected seller 130.

Upon determining (360) that the equivalent hypothetical sale of the prescription-based product would be profitable from the selected seller 130, the method may proceed to initiate a transfer (370) of the indication, typically a prescription, from the primary seller 120 to the selected seller 130. The selected seller 130 may then proceed to fulfill the order normally.

In some embodiments, the server 110 may be provided with access to various data sources 125 associated with the primary seller 120. Such access may be read-only access by way of communication pathways 220 or it may be direct access, in some embodiments. As such, while the server 110 may receive the indication, or prescription data, from the primary seller 120, the server may, alternatively, receive the indication, or prescription data 150 from a health care provider directly. Such prescription data 150 may then indicate a patient as the buyer.

Typically, the prescription data 150 is initially received at the server 110 from the primary seller 120 by way of the communication pathway 170 linking the pharmacy with the server. The initiation of the transfer of the indication (at 370) is then a transfer of the prescription from the primary seller 120 to the selected seller 130.

Alternatively, the prescription data 150 may be received directly from the health care provider by way of a secondary communication pathway 220. The prescription data 150 may then indicate the primary seller 120 as a preferred pharmacy. Accordingly, the transfer of the prescription data may be by coordinating a direct transfer from the primary seller 120, or it may be directly providing the prescription data 150 from the central server 110.

The evaluation of the hypothetical sale from the primary seller (at 310) may be based at least partially on data retrieved from the primary seller 120 by way of the communication pathway 170 following receipt of the indication (at 300) at the exchange platform 110. Alternatively, or in addition, some of the data may be retrieved from the secondary data sources 140, 160 directly by way of the secondary communication pathway 220 discussed above. In any event, the data retrieved from data sources 125 and used for the corresponding evaluation (at 310) is associated with the primary seller 120 and is typically proprietary and/or confidential. As discussed above, the data retrieved from the primary seller 120 may indicate product purchase data and payer reimbursement data unique to the primary seller.

Similarly, the evaluation of the equivalent hypothetical sale from the selected seller 130 is based on data retrieved from data sources 135 associated with the selected seller following the determination that the hypothetical sale from the primary seller 120 would not be profitable (at 320). As discussed above, the data may be retrieved from the secondary seller 130 by way of a communication pathway 170 and/or directly from corresponding sources 140, 160 associated with the secondary seller 130. The data retrieved and associated with the selected seller 130 is typically proprietary and/or confidential. The data retrieved from the selected seller 130 may indicate product purchase data and payer reimbursement data unique to the selected seller, and it may be different than that associated with the first seller 120.

Typically, data retrieved from or associated with the primary seller 120 is not accessible by the selected seller 130 and data retrieved from or associated with the selected seller 130 is not accessible by the selected seller 130. Accordingly, the platform may maintain confidentiality between the different potential sellers, and perform comparisons and analyses that the parties would not themselves be able to execute.

In some embodiments, the communication pathways 170 associated with the primary seller 120 and the selected seller 130 are maintained actively, such that the retrieval of data may occur in real time, or close to it. In this way, the platform 110 may be usable at the primary seller 120 as a point-of-sale module, and information about where a prescription can be filled may be provided to a customer in real time or in near real time.

In some embodiments, the evaluation of the hypothetical sale from the primary seller 120 (at 310) and the evaluation of the equivalent hypothetical sale from the at least one secondary seller 130 (at 350) are each further based on available reimbursements from a manufacturer or payer applicable to either hypothetical sale. Accordingly, data associated with reimbursements may be accessed at a database 200 directly accessible by the exchange platform 110. Typically, such programs would not be confidential, but if they were, such data can be provided by the manufacturers to the platform confidentially.

In some embodiments, following the transfer of the indication (at 370) to the selected seller 130, the platform may transmit a notice (380) to the buyer or to the primary seller 120 to indicate that the indication, in this case a prescription, is being processed by the selected seller 130.

In some embodiments, the method further includes maintaining an account associated with each seller 120, 130 utilizing the platform. Accordingly, the primary seller 120 and a plurality of secondary sellers, including the selected seller 130 may be provided with accounts. The method may then be performed repeatedly for different indications or prescriptions, and the method may then update user accounts (390) in order to track a plurality of transfers of indications from the primary seller 120 to a plurality of secondary sellers, including the selected seller 130, over time.

Accordingly, upon confirming a transfer of the indication (at 370) from the primary seller to the selected seller, the method may apply a transfer fee to the account of the primary seller 120 and charge the transfer fee to the account of the selected seller 130. In some embodiments, these transfer fees may be symmetric, such that the fee paid by the selected seller 130 is equivalent to the fee received by the primary seller 120 for the transfer. In some embodiments, the selected seller 130 may pay an additional fee, such as a “rake” to the platform 110 as profit for a platform operator. In such an embodiments, the fee paid by the selected seller 130 would be more than that received by the primary seller 120.

In some embodiments, the primary seller 120 may take some payment from the buyer. For example, the primary seller may take payment for out-of-pocket expenses, such as copayments. In such an embodiments, the platform 110 may receive a confirmation that the buyer has made a partial payment to the primary seller. Upon receiving such a confirmation, the method may transmit a corresponding indication to the selected seller that partial payment has been received, and the method may then apply a corresponding credit to the account of the selected seller in accordance with the partial payment. In this way, if a buyer pays a copay to their primary pharmacy 120, this copay could be applied to the sale, and they would not need to pay the selected seller 130 separately.

In some embodiments, the buyer may attempt to execute the prescription based sale in a physical store associated with the primary pharmacy 120, and the buyer's primary pharmacy may then access the platform 110 by way of their point of sale console or other interface device 120. In such an embodiment, the pharmacy may submit the prescription to the platform 110 and determine that it should be filled by a selected pharmacy 130. If the selected pharmacy 130 can fulfill the prescription by mail, the method may proceed to initiate an order corresponding to the indication. The user may then pay their copay to the primary pharmacy 120 and receive their medication by mail, resulting in a seamless transaction. Payments, such as the copayment already paid, and other logistics, can then be handled by the platform 110 on the back end without the buyer being exposed to the same.

Accordingly, in some embodiments, from the buyer's perspective, their purchase is from the primary pharmacy 120, even if fulfillment is handled by a third party, namely the selected seller 130. Accordingly, as discussed above, the platform 110 may have data access to data related to patient engagement programs 210 of the primary seller 120. Accordingly, the method may further include assigning loyalty points associated with the primary seller 120 to the buyer upon the buyer purchasing the prescription-based product from the selected seller 130.

In some embodiments, as noted above, in identifying a selected seller 130, the method may iteratively evaluate (at 350) several potential sellers of the plurality of available secondary sellers. For any such seller, if the method determines (360) that the equivalent hypothetical sale would not be profitable, the method returns to a list of sellers in an attempt to identify a selected seller. In some scenarios, no sellers in such a database may be able to profitably fulfill a particular subscription. Accordingly, upon determining that the equivalent hypothetical sale from the selected seller would not be profitable (at 360), the method may proceed to initiate a transfer of the indication (400), in this case the prescription, from the primary seller 120 to a backup pharmacy 230. Such a backup pharmacy 230 may have committed preemptively to fulfilling orders for eligible prescription-based products.

It is noted that throughout this discussion, profitability of a particular transaction may be evaluated based on criteria generated by or provided by the individual sellers 120, 130. Accordingly, in some embodiments, the determination that the sale of the prescription-based product would or would not be profitable may be based on net profit compared to a minimal threshold profit. In this way the seller 120, 130 may define a threshold profit that would make the transaction worthwhile for them, and the method may then use that as a threshold for determining profitability.

The swim lane diagram of FIG. 3 provides additional context for the system 100 and method described herein, and illustrates the method as performed by an exchange platform operating on a server 110 and the relationship between the server, the primary pharmacy 120, the secondary pharmacy 130, and the national backup pharmacy 230.

As shown, each of the pharmacies, utilizing their respective interface devices 120, 130, 230, may have their own discrete CRM, purchase, and payer reimbursement platforms. As such, each pharmacy 120, 130, 230 is equipped to independently process a prescription 150 transmitted to them.

As shown, the healthcare provider may transmit some notice to the central server 110 operating the exchange platform, but typically, the prescription is first received by the primary pharmacy 120 which then provides the same to the platform (at 300)

The platform 110 may then initially check completeness of the prescription and/or eligibility for execution on the platform shown (at 305) and, in some cases, may refuse handling. For example, if acute treatment is needed by a patient immediately, the platform 110 may advise the primary pharmacy 120 to execute (at 325), even at a loss.

If the platform determines that the prescription is eligible for handling (at 205), the method may then evaluate the hypothetical sale of the prescription-based product by the primary pharmacy 120. Accordingly, the platform may request additional information from the primary pharmacy 120 and/or related data sources 140, 160, and evaluate the sale on that basis (at 310).

If the transaction is determined to be profitable (at 320), based on the determined criteria for that pharmacy 120, the platform 110 may instruct the primary pharmacy to execute the transaction (at 325).

If the transaction is instead determined not to be profitable (at 320), the method proceeds to identify a secondary pharmacy (at 340), request additional information from the secondary pharmacy 130 and/or related data sources 140, 160, and evaluate the sale on that basis (350). As noted above, in either evaluation (310, 350), the system 110 may retrieve additional information from data sources not specific to either pharmacy 120, 130, such as manufacturing rebate programs 200 and other support programs.

If the method determines (at 360) that the equivalent hypothetical sale at the secondary pharmacy 130 would be profitable, the method proceeds to initiate a transfer (370) of the prescription 150 to the selected secondary pharmacy 130. If the equivalent hypothetical sale is determined (at 360) not to be profitable, the method proceeds to determine if additional secondary pharmacies 130 are available (365), and repeats the process of identifying a secondary pharmacy (340) and evaluating an equivalent hypothetical sale (at 350).

In some embodiments, if all available secondary pharmacies 130 are determined not to be able to profitably execute an equivalent transaction (at 360), and no additional secondary sellers are available, the method may then transfer the prescription to a backup pharmacy 230 (at 400), typically a pharmacy that has agreed preemptively to function as a backstop, even where fulfillment is not profitable. In some scenarios, the national backup pharmacy 230 may have access to additional manufacturing programs and support, and as such, the programs may allow the transaction to generate some profit or mitigate loss. Otherwise, the backup pharmacy 230 may execute at a loss.

Finally, in some scenarios, the backup pharmacy 230 may be unable or unwilling to execute. This may be the case where a particular transaction is outside the bounds or scope of the set of transactions the pharmacy 230 has preemptively agreed to execute. In such a scenario, the platform 110 may be unable to execute, and the prescription is returned to, or is retained by, the primary pharmacy 120 for handling.

In an embodiment of the present invention, some or all of the method components are implemented as a computer executable code. Such a computer executable code contains a plurality of computer instructions that when performed in a predefined order result with the execution of the tasks disclosed herein. Such computer executable code may be available as source code or in object code, and may be further comprised as part of, for example, a portable memory device or downloaded from the Internet, or embodied on a program storage unit or computer readable medium. The principles of the present invention may be implemented as a combination of hardware and software and because some of the constituent system components and methods depicted in the accompanying drawings may be implemented in software, the actual connections between the system components or the process function blocks may differ depending upon the manner in which the present invention is programmed.

The computer executable code may be uploaded to, and executed by, a machine comprising any suitable architecture. Preferably, the machine is implemented on a computer platform having hardware such as one or more central processing units (“CPU”), a random access memory (“RAM”), and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

The functions of the various elements shown in the figures may be provided through the use of dedicated hardware as well as hardware capable of executing appropriate software. When provided by a processor, the functions may be provided by a single dedicated processor, by a single shared processor, or by a plurality of individual processors, some of which may be shared. Explicit use of the term “processor” or “controller” should not be construed to refer exclusively to hardware capable of executing software, and may implicitly include, without limitation, digital signal processor hardware, ROM, RAM, and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A computer-based method for coordinating a purchase, the method comprising:
receiving, at an exchange platform, an indication that a buyer wishes to purchase a prescription-based product from a primary seller;
evaluating a hypothetical sale of the prescription-based product from the primary seller;
upon determining that the hypothetical sale of the prescription-based product from the primary seller would not be profitable, evaluating an equivalent hypothetical sale from at least one secondary seller; and
upon determining that the equivalent hypothetical sale from a selected seller of the at least one secondary seller would be profitable, initiating a transfer of the indication from the primary seller to the selected seller.

2. The method of claim 1 wherein the indication that a buyer wishes to purchase the prescription-based product is a prescription from a health care provider indicating a patient as the buyer.

3. The method of claim 2 wherein the prescription is initially received at the exchange platform from the primary seller, and wherein the initiation of the transfer of the indication is a transfer of the prescription from the primary seller to the selected seller.

4. The method of claim 2, wherein the prescription is initially received from the health care provider and indicates the primary seller as a preferred pharmacy.

5. The method of claim 1 wherein the evaluation of the hypothetical sale from the primary seller is based at least partially on data retrieved from or associated with the primary seller following the receipt of the indication at the exchange platform, and wherein the evaluation of the equivalent hypothetical sale from the selected seller is based on data retrieved from or associated with the selected seller following the determination that the hypothetical sale from the primary seller would not be profitable.

6. The method of claim 5 wherein the data retrieved from or associated with the primary seller is not accessible by the selected seller and the data retrieved from or associated with the selected seller is not accessible by the primary seller.

7. The method of claim 5 further comprising maintaining communication pathways with each of the primary seller and the selected seller such that the retrieval of data occurs in real time.

8. The method of claim 5 wherein the data retrieved from the primary seller indicates product purchase data and payer reimbursement data unique to the primary seller and wherein the data retrieved from the selected seller indicates product purchase data and payer reimbursement data unique to the selected seller and different than that of the first seller.

9. The method of claim 8 wherein the evaluation of the hypothetical sale from the primary seller and the evaluation of the equivalent hypothetical sale from the at least one secondary seller are each further based on available reimbursements from a manufacturer or payer applicable to either hypothetical sale.

10. The method of claim 1 further comprising transmitting a notice to the buyer or to the primary seller that the indication is being processed by the selected seller.

11. The method of claim 1 further comprising maintaining an account for each of the primary seller and the at least one secondary seller, and wherein the method is performed repeatedly, and wherein the method further comprises tracking a plurality of transfers of indications from the primary seller to a plurality of sellers of the at least one secondary seller including the selected seller over time.

12. The method of claim 11, wherein upon confirming a transfer of the indication from the primary seller to the selected seller, applying a transfer fee to the account of the primary seller and charging the transfer fee to the account of the selected seller.

13. The method of claim 11 further comprising upon receiving confirmation that the buyer has made a partial payment to the primary seller, transmitting an indication to the selected seller that partial payment has been received, and applying a credit to the account of the selected seller in accordance with the partial payment.

14. The method of claim 11 further comprising assigning loyalty points associated with the primary seller to the buyer upon the buyer purchasing the prescription-based product from the selected seller.

15. The method of claim 1 wherein upon determining that the equivalent hypothetical sale from the selected seller would not be profitable, the method further comprises initiating a transfer of the indication from the primary seller to a backup pharmacy, wherein the backup pharmacy commits preemptively to fulfilling orders for eligible prescription-based products.

16. The method of claim 1, wherein the selected seller is a mail order pharmacy, such that upon confirming a transfer of the indication from the primary seller to the selected seller, the method further comprises initiating an order corresponding to the indication.

17. The method of claim 1, wherein the determination that the sale of the prescription-based product from the primary seller would not be profitable is based on net profit compared to a minimal threshold profit.

18. A system for coordinating a purchase, the system comprising:
a server;
a primary seller interface device; and
a secondary seller interface device;
wherein the primary seller interface device receives an indication that a buyer wishes to purchase a prescription-based product from the primary seller;
the primary seller interface device then transmits an indication to the server that the buyer wishes to purchase the prescription-based product from the primary seller;
the server retrieves primary seller confidential data associated with the primary seller interface device and evaluates a hypothetical sale of the prescription-based product from the primary seller based at least partially on the primary seller confidential data;
upon determining that the hypothetical sale of the prescription-based product from the primary seller would not be profitable, the server further retrieves secondary seller confidential data associated with the secondary seller interface device and evaluates an equivalent hypothetical sale of the prescription-based product from the secondary seller based at least partially on the secondary seller confidential data; and
upon determining that the equivalent hypothetical sale from the secondary seller would be profitable, initiating a transfer of the indication from the primary seller interface device to the secondary seller interface device.

19. The system of claim 18 further comprising a database external to the server, the primary seller interface device and the secondary seller interface device, the database containing primary seller confidential data or secondary seller confidential data, and wherein the server retrieves confidential data from the database upon authorization of such retrieval by the corresponding primary seller interface device or secondary seller interface device.

20. The system of claim 18, wherein the primary seller interface device is a computer system associated with a primary pharmacy, and wherein the secondary seller interface device is a computer system associated with a secondary pharmacy, and wherein the indication is a prescription issued by a healthcare provider.
